(19) United States
(12) Patent Application Publication
(10) Pub. No.: US 2017/0237317 A1
(43) Pub. Date: Aug. 17, 2017

(54) COMPRESSOR SYSTEM

(71) Applicant: MITSUBISHI HEAVY INDUSTRIES, LTD., Tokyo (JP)

(72) Inventor: Satoshi MIZUKAMI, Tokyo (JP)

(73) Assignee: MITSUBISHI HEAVY INDUSTRIES, LTD., Tokyo (JP)

(21) Appl. No.: 15/514,880

(22) PCT Filed: Nov. 10, 2015
(86) PCT No.: PCT/JP2015/081567

§ 371 Date: Mar. 28, 2017

(30) Foreign Application Priority Data
Feb. 23, 2015 (JP) 2015-032801
Feb. 23, 2015 (JP) 2015-032802

(51) Int. Cl. H02K 9/193; H02K 7/14; F04D 25/06; H02K 1/20; F04D 29/58; E21B 43/12

(52) U.S. Cl. CPC H02K 9/193; F04D 29/5806; E21B 43/121; F04D 25/06; H02K 1/20; H02K 7/14

(57) ABSTRACT

A compressor system (1) includes a motor including a rotor (31) that rotates and a stator (32), a compressor configured to compress a working fluid by rotating together with the rotor (31), a heat exchanger (61) configured to cool a cooling medium that has circulated inside the stator (32) or in a gap (33) between the stator (32) and the rotor (31), and a cooling flow path (64) through which the cooling medium is supplied to the heat exchanger (61) and the cooling medium cooled by the heat exchanger (61) is circulated again inside the stator (32) or in the gap (33) between the stator (32) and the rotor (31).

### TECHNICAL FIELD

The present invention relates to a compressor system.

Priority is claimed on Japanese Patent Application No. 2015-032801, filed Feb. 23, 2015 and No. 2015-032802 filed Feb. 23, 2015, the content of which is incorporated herein by reference.

### BACKGROUND ART

A compressor system in which a motor and a compressor are integrated includes a compressor configured to compress vapor such as air and a gas and a motor configured to drive the compressor. In the compressor system, a rotation shaft that extends from a casing of the compressor and a rotation shaft of the motor that similarly extends from a casing of the motor are connected. The rotation of the motor is transmitted to the compressor. The rotation shafts of the motor and the compressor are supported by a plurality of bearings and thus reliably rotate.

Such a compressor system is used, for example, for a subsea production system as in Non-Patent Literature 1 or a Floating Production Storage and Offloading (FPSO) unit as in Non-Patent Literature 2. When the compressor system is used for the subsea production system, the compressor system is installed in the seabed and sends production fluids mixed with crude oils and natural gases that are drawn from production wells drilled to a depth of several thousand meters in the seabed to the sea surface. When the compressor system is used for the FPSO unit, the compressor system is installed in a marine facility such as a ship.

### CITATION LIST

### Non-Patent Literature

### [Non-Patent Literature 1]

Mitsubishi Heavy Industries Technical Review Vol. 34 No. 5 P310-P313

### [Non-Patent Literature 2]

Turbomachinery International September/October 2014 P18-P24

### SUMMARY OF INVENTION

### Technical Problem

In a motor of a compressor system, when a rotor rotates at a high speed, heat is generated between the rotor and the stator and the rotor and the stator are heated to a high temperature. When the rotor and the stator are heated to a high temperature, there is a possibility of efficiency of the motor decreasing. Therefore, it is necessary to cool the rotor and the stator.

However, when a cooling medium is circulated inside the stator or in a gap between the stator and the rotor from one side to the other side in an axis direction of the rotor and cools the rotor and the stator, the cooling medium is heated during circulation. As a result, it is difficult to efficiently cool the rotor and the stator.

The present invention provides a compressor system capable of efficiently cooling a rotor and a stator.

### Solution to Problem

In order to address the above problems, the present invention proposes the following solutions. A compressor system according to a first aspect of the present invention includes a motor including a rotor configured to rotate about an axis and a stator that is disposed on an outer circumference side of the rotor; a compressor configured to compress a working fluid by rotating together with the rotor; a heat exchanger configured to cool a cooling medium that has circulated inside the stator or in a gap between the stator and the rotor; and a cooling flow path through which the cooling medium that has circulated inside the stator or in the gap between the stator and the rotor is supplied to the heat exchanger and the cooling medium cooled by the heat exchanger is circulated again inside the stator or in the gap between the stator and the rotor.

In such a configuration, it is possible to efficiently cool the cooling medium to a temperature to which it is necessary for the stator and the rotor to be cooled by the heat exchanger. When the cooling medium cooled by the heat exchanger is circulated in the cooling flow path, it is possible to circulate the cooling medium that is sufficiently cooled inside the stator or in a gap between the stator and the rotor.

In a compressor system according to a second aspect of the present invention, in the first aspect, the cooling flow path may include an intermediate cooling flow path through which the cooling medium that circulates inside the stator or in the gap between the stator and the rotor is supplied to the heat exchanger along the way in an axis direction inside the stator or the gap between the stator and the rotor and the cooling medium cooled by the heat exchanger flows into the stator or the gap between the stator and the rotor.

In such a configuration, through the intermediate cooling flow path, the cooling medium can be discharged to the outside of the stator along the way in the axis direction and supplied to the heat exchanger, and the cooling medium cooled by the heat exchanger can be circulated. Therefore, it is possible to cool the rotor and the stator by the cooling medium that is cooled again by the heat exchanger along the way in the axis direction. That is, it is possible to prevent the cooling medium from being heated to cool the rotor and the stator during circulation and prevent an area along the way in the axis direction of the rotor and the stator from not being sufficiently cooled. Therefore, when the cooling mediums cooled by the heat exchanger are circulated in the axis direction, it is possible to suppress temperature irregularity in the axis direction and cool the rotor and the stator.

In a compressor system according to a third aspect of the present invention, in the second aspect, a plurality of the intermediate cooling flow paths may be provided in the axis direction with respect to the stator.

In such a configuration, when the plurality of intermediate cooling flow paths are included, it is possible to cool again the cooling medium, the temperature of which has increased at a plurality of locations in the axis direction by the heat exchanger. Therefore, it is possible to circulate the cooling medium that is newly cooled at a plurality of locations in the axis direction. Therefore, it is possible to further improve cooling efficiency of the rotor and the stator in the axis direction.

In a compressor system according to a fourth aspect of the present invention, in any one of the first to third aspects, the heat exchanger may cool the cooling medium using air.

In a compressor system according to a fifth aspect of the present invention, in any one of the first to third aspects, the heat exchanger may cool the cooling medium using fresh water.

In a compressor system according to a sixth aspect of the present invention, in any one of the first to third aspects, the heat exchanger may cool the cooling medium using seawater.

In a compressor system according to a seventh aspect of the present invention, in any one of the first to third aspects, the cooling medium may be a compressed fluid extracted from the compressor.

In such a configuration, it is possible to form the cooling flow path with a simple configuration.

A compressor system according to an eighth aspect of the present invention includes a motor including a rotor configured to rotate about an axis and a stator that is disposed on an outer circumference side of the rotor; a compressor configured to compress a working fluid by rotating together with the rotor; a first flow path that is disposed on one side in an axis direction and through which a cooling medium that has circulated inside the stator or in a gap between the stator and the rotor is recycled and is circulated again inside the stator or in the gap between the stator and the rotor; and a second flow path which is adjacent to the first flow path at an interval therefrom in the axis direction and through which a cooling medium that has circulated inside the stator or in the gap between the stator and the rotor is recycled and is circulated again inside the stator or in the gap between the stator and the rotor.

In such a configuration, through the first flow path and the second flow path, the rotor and the stator that are elongated in the axis direction can be separately cooled in the axis direction in short divided sections. An area to be cooled is divided into short sections and the rotor and the stator are cooled by a cooling medium that circulates in another system. Therefore, it is possible to prevent the occurrence of an area that is not sufficiently cooled.

In a compressor system according to a ninth aspect of the present invention, in the eighth aspect, a heat exchanger configured to cool the cooling medium that has circulated inside the stator or in the gap between the stator and the rotor may be included.

In such a configuration, it is possible to efficiently cool the cooling medium to a temperature to which it is necessary for the stator and the rotor to be cooled by the heat exchanger. The cooling medium cooled by the heat exchanger circulates in the first flow path and the second flow path. Therefore, it is possible to circulate the cooling medium that is sufficiently cooled inside the stator or in a gap between the stator and the rotor.

In a compressor system according to a tenth aspect of the present invention, in the ninth aspect, the heat exchanger may cool the cooling medium that circulates in the first flow path and cool the cooling medium that circulates in the second flow path.

In such a configuration, the cooling mediums can be cooled by the heat exchanger common to the first flow path and the second flow path. Therefore, it is possible to configure the first flow path and the second flow path with fewer components.

In a compressor system according to an eleventh aspect of the present invention, in the tenth aspect, the heat exchanger may cool the cooling medium using air.

In a compressor system according to a twelfth aspect of the present invention, in the tenth aspect, the heat exchanger may cool the cooling medium using fresh water.

In a compressor system according to a thirteenth aspect of the present invention, in the tenth aspect, the heat exchanger may cool the cooling medium using seawater.

In a compressor system according to a fourteenth aspect of the present invention, in any one of the eighth to thirteenth aspects, the cooling medium may be a compressed fluid extracted from the compressor.

In such a configuration, it is possible to form the cooling flow path with a simple configuration.

### Advantageous Effects of Invention

According to the compressor system of the present invention, when the cooling medium cooled by the heat exchanger is circulated from the cooling flow path, it is possible to efficiently cool the rotor and the stator.

According to the compressor system of the present invention, when the cooling mediums circulate in the first flow path and the second flow path that are formed apart in the axis direction, it is possible to effectively cool the rotor and the stator.

### BRIEF DESCRIPTION OF DRAWINGS

FIG. 1 is a schematic diagram describing a compressor system according to a first embodiment and a second embodiment of the present invention.

FIG. 2 is a schematic diagram showing a cooling portion of the compressor system according to the first embodiment of the present invention.

FIG. 3 is a schematic diagram showing a cooling portion of the compressor system according to the second embodiment of the present invention.

FIG. 4 is a schematic diagram describing a compressor system according to a third embodiment of the present invention.

FIG. 5 is a schematic diagram showing a cooling portion of the compressor system according to the third embodiment of the present invention.

FIG. 6 is a schematic diagram showing a cooling portion of the compressor system according to the fourth embodiment of the present invention.

### DESCRIPTION OF EMBODIMENTS

### First Embodiment

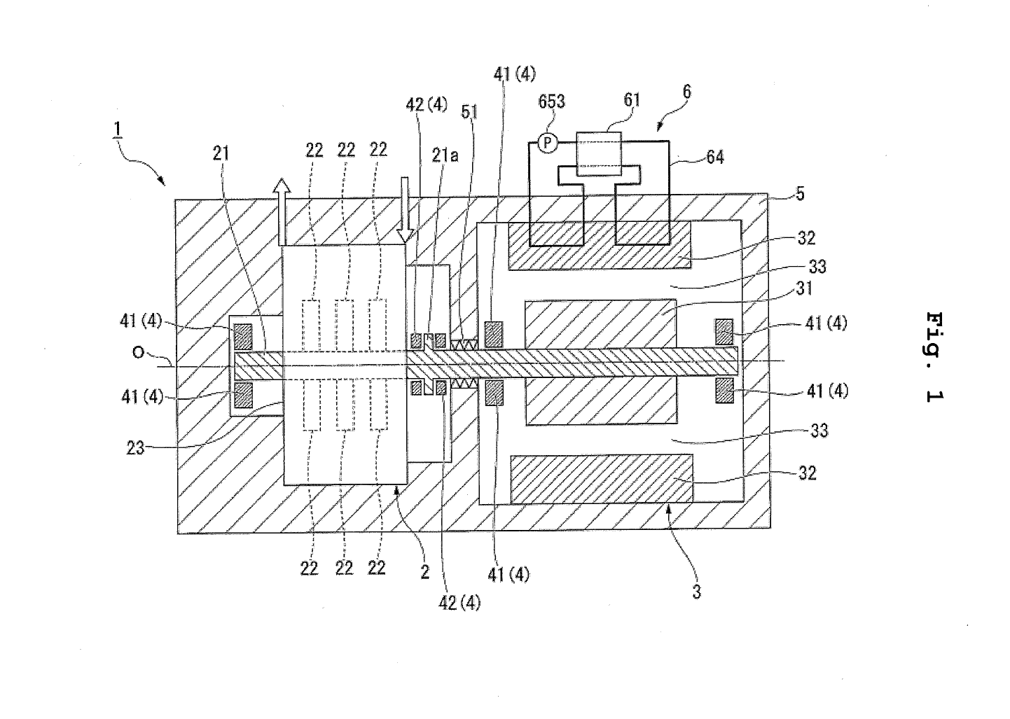

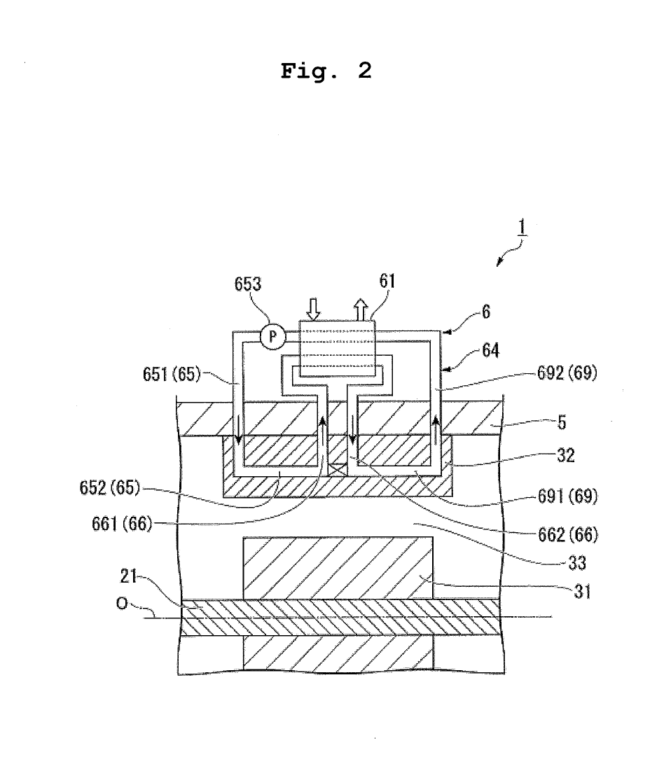

A first embodiment according to the present invention will be described below with reference to FIG. 1 and FIG. 2.

A compressor system 1 can be used in a subsea production system that is one of ocean oil and gas field development systems and is provided on the seabed, and can be also used in a Floating Production Storage and Offloading (FPSO) unit and is provided on the sea surface. The compressor system 1 pressure-feeds a production fluid such as oils and gases harvested from oil gas field production wells located several hundreds to thousands of meters from the seabed as a working fluid.

As shown in FIG. 1, the compressor system 1 includes a compressor 2, a motor 3, a bearing 4, a casing 5, and a cooling portion 6. The compressor 2 extends in an O axis direction (in a horizontal direction in FIG. 1) as a rotation axis. The motor 3 includes a rotor 31 that is directly connected to a shaft 21. The bearing 4 supports the shaft 21. The casing 5 accommodates the motor 3 and the compressor 2. The cooling portion 6 cools the motor 3. The compressor system 1 of this embodiment is a motor compressor in which a motor and a compressor are integrated.

The compressor 2 is accommodated inside the casing 5. The compressor 2 compresses a working fluid when the shaft 21 rotates about an O axis together with the rotor 31. The compressor 2 of this embodiment includes the shaft 21, an impeller 22, and a housing 23. The shaft 21 extends in the O axis direction. The impeller 22 is fixed to an outer circumference surface of the shaft 21. The housing 23 accommodates the impeller 22.

The shaft 21 is a rotation shaft that extends in the O axis direction. The shaft 21 is supported by the casing 5 to be rotatable about the O axis. The shaft 21 passes through the housing 23. The shaft 21 has ends both of which extend from the housing 23. The shaft 21 extends in the O axis direction in the casing 5 to be described below.

The impeller 22 rotates together with the shaft 21. The impeller 22 compresses a working fluid that passes through the inside of the impeller 22 and generates a compressed fluid.

The housing 23 is an exterior of the compressor 2. The housing 23 accommodates the impeller 22 therein. The housing 23 is accommodated inside the casing 5.

The motor 3 is accommodated inside the casing 5 at an interval from the compressor 2 in the O axis direction. The motor 3 includes the rotor 31 and a stator 32. The rotor 31 is fixed so as to be integrated with the shaft 21. The stator 32 is disposed on an outer circumference side of the rotor 31.

The rotor 31 is integrated with the shaft 21 and rotatable about the O axis. The rotor 31 is directly connected to an outer circumference side of the shaft 21, which is the outside in a circumferential direction with respect to the O axis, such that it is integrated with the shaft 21 of the compressor 2 without a gear and the like intervening and rotates. The rotor 31 includes, for example, a rotor core (not shown) through which an induced current flows when the stator 32 generates a rotating magnetic field.

The stator 32 is provided such that there is a gap 33 in the circumferential direction to cover the rotor 31 from the outer circumference side. The stator 32 includes a plurality of stator cores (not shown) that are disposed in, for example, the circumferential direction of the rotor 31 and a stator winding (not shown) wound on the stator core. When a current flows from the outside, the stator 32 generates a rotating magnetic field and rotates the rotor 31. The stator 32 is fixed into the casing 5.

The bearing 4 is accommodated inside the casing 5. The bearing 4 rotatably supports the shaft 21. The bearing 4 of this embodiment includes a plurality of journal bearings 41 and thrust bearings 42.

The journal bearing 41 supports a load on the shaft 21 in a radial direction with respect to the O axis. Journal bearings 41 are disposed at both ends of the shaft 21 in the O axis direction to sandwich the motor 3 and the compressor 2 in the O axis direction. The journal bearing 41 is also disposed between an area in which the compressor 2 is provided and an area in which the motor 3 is provided, which is on the motor 3 side relative to a sealing member 51 to be described below.

The thrust bearing 42 supports a load on the shaft 21 in the O axis direction through a thrust collar 21a that is formed at the shaft 21. The thrust bearing 42 is disposed between the area in which the compressor 2 is provided and the area in which the motor 3 is provided and is on the compressor 2 side relative to the sealing member 51 to be described below.

The casing 5 accommodates the compressor 2 and the motor 3 therein. The casing 5 has a cylindrical shape along the O axis. An inner surface of the casing 5 protrudes toward the shaft 21 between the compressor 2 and the motor 3 in the O axis direction. The casing 5 is provided on a portion from which the sealing member 51 sealing a gap between the area in which the compressor 2 is provided and the area in which the motor 3 is provided protrudes.

The cooling portion 6 cools the rotor 31 and the stator 32. The cooling portion 6 of this embodiment includes a heat exchanger 61 and a cooling flow path 64. The heat exchanger 61 cools a cooling medium that has circulated inside the stator 32. Through the cooling flow path 64, the cooling medium that has circulated inside the stator 32 is supplied to the heat exchanger 61. In the cooling flow path 64, the cooling medium cooled by the heat exchanger 61 is circulated again inside the stator 32.

As the cooling medium, for example, a gas such as air and helium is preferably used. When a gas such as air and helium is used, compared to a gas including a large amount of liquid content such as a liquid and water vapor, it is possible to suppress oxidation of metal materials forming the heat exchanger 61 and the cooling flow path 64 and a decrease in strength.

A part of a compressed fluid compressed by the compressor 2 may be extracted and used as the cooling medium. When the compressed fluid of the compressor 2 is used as the cooling medium, it is possible to circulate the cooling medium in the cooling flow path 64 without using a device configured to send a cooling medium such as a pump 653. Therefore, it is possible to form the cooling flow path 64 with a simple configuration.

The heat exchanger 61 cools the cooling medium that has circulated inside the stator 32 through the cooling flow path 64 and heated to a high temperature. The heat exchanger 61 of this embodiment is disposed outside the casing 5. The heat exchanger 61 exchanges heat between a surrounding secondary cooling medium and the cooling medium. Therefore, the heat exchanger 61 cools the cooling medium to a temperature to which it is appropriate to cool the motor 3.

When the compressor system 1 is used for the subsea production system and is provided in the seabed, the surrounding seawater is preferably used as the secondary cooling medium. When the surrounding seawater is used, there is no need to provide an additional secondary cooling medium for the heat exchanger 61. When the surrounding seawater is used, it is possible to cool the cooling medium to a temperature to which it is possible to sufficiently cool the motor 3 by simply exchanging heat with low temperature seawater in the seabed.

When the compressor system 1 is used for FPSO and is provided in a marine facility such as a ship, the surrounding air or fresh water stored in the marine facility is preferably used as the secondary cooling medium. When the surrounding air or fresh water is used, there is no need to provide an additional secondary cooling medium for the heat exchanger 61. When the surrounding air or fresh water is used, it is possible to cool the cooling medium to a temperature to which it is possible to sufficiently cool the motor 3 while suppressing the occurrence of an event such as corrosion of a pipe.

Through the cooling flow path 64, the cooling medium is circulated inside the stator 32 and the rotor 31 and the stator 32 are cooled. As shown in FIG. 2, the cooling flow path 64 of this embodiment is a closed loop flow path through which the cooling medium is recycled between the heat exchanger 61 and the motor 3. The cooling flow path 64 includes a downstream side cooling flow path 65, an intermediate cooling flow path 66, and an upstream side cooling flow path 69. Through the downstream side cooling flow path 65, the cooling medium cooled by the heat exchanger 61 is circulated inside the stator 32 on a downstream side in the O axis direction. Through the intermediate cooling flow path 66, the cooling medium is supplied from the downstream side cooling flow path 65 to the heat exchanger 61 along the way in the O axis direction and is returned again into the stator 32. The upstream side cooling flow path 69, through which the cooling medium is circulated in the stator 32 on an upstream side in the O axis direction, is connected to the intermediate cooling flow path 66.

Here, a side on which the compressor 2 is disposed with respect to the motor 3 in the O axis direction is defined as a downstream side (the left side in FIG. 2) in the O axis direction. A side opposite to the downstream side is defined as an upstream side (the right side in FIG. 2) in the O axis direction.

The downstream side cooling flow path 65 includes an introduction flow path 651 and a downstream side circulation flow path 652. Through the introduction flow path 651, the cooling medium is introduced into the stator 32 from the heat exchanger 61 on the downstream side in the O axis direction. The downstream side circulation flow path 652, through which the cooling medium is circulated inside the stator 32 in the O axis direction, is connected to the introduction flow path 651.

Through the introduction flow path 651, the cooling medium cooled by the heat exchanger 61 is introduced into the stator 32 from the outside of the casing 5. The introduction flow path 651 is a pipe that is connected to the inside of the stator 32 from the heat exchanger 61 on the downstream side in the O axis direction of the stator 32. The pump 653 configured to pressure-feed a cooling medium is provided along the introduction flow path 651.

When the downstream side circulation flow path 652 is disposed inside the stator 32, the cooling medium is circulated inside the stator 32. Through the downstream side circulation flow path 652 of this embodiment, the cooling medium is circulated to the upstream side from the downstream side in the O axis direction. The downstream side circulation flow path 652 is a pipe that extends in the O axis direction at a portion close to the rotor 31 in the radial direction inside the stator 32. The downstream side circulation flow path 652 extends to an intermediate position in the rotor 31 in the O axis direction from a position on the downstream side in the O axis direction relative to the rotor 31 inside the stator 32. An end of the downstream side circulation flow path 652 on the downstream side in the O axis direction is connected to the introduction flow path 651.

Through the intermediate cooling flow path 66, the cooling medium that circulates inside the stator 32 is supplied to the heat exchanger 61 along the way inside the stator 32 in the O axis direction. Through the intermediate cooling flow path 66, the cooling medium cooled by the heat exchanger 61 flows again into the stator 32. The intermediate cooling flow path 66 is formed at an intermediate position in the stator 32 in the O axis direction. The intermediate cooling flow path 66 includes an intermediate discharge flow path 661 and an intermediate introduction flow path 662. Through the intermediate discharge flow path 661, the cooling medium is discharged from the inside of the stator 32 along the way inside the stator 32 in the O axis direction and is supplied to the heat exchanger 61. Through the intermediate introduction flow path 662, the cooling medium is introduced into the stator 32 from the heat exchanger 61 along the way in the O axis direction inside the stator 32.

Through the intermediate discharge flow path 661, the cooling medium that has circulated in the downstream side circulation flow path 652 and whose temperature has increased is supplied from the inside of the stator 32 to the outside of the casing 5 and is supplied to the heat exchanger 61. The intermediate discharge flow path 661 is a pipe that is connected to the heat exchanger 61 from the downstream side circulation flow path 652 at the intermediate position in the stator 32 in the O axis direction. The intermediate discharge flow path 661 is connected to an end of the downstream side circulation flow path 652 on the upstream side in the O axis direction.

Through the intermediate introduction flow path 662, the cooling medium cooled by the heat exchanger 61 is introduced again into the stator 32 from the outside of the casing 5. The intermediate introduction flow path 662 is a pipe that is connected to the upstream side cooling flow path 69 from the heat exchanger 61 at the intermediate position in the stator 32 in the O axis direction. The intermediate introduction flow path 662 is disposed at an interval from the intermediate discharge flow path 661 by the side on the upstream side in the O axis direction inside the stator 32. The intermediate introduction flow path 662 is formed to have the same length as the intermediate discharge flow path 661.

The upstream side cooling flow path 69 includes an upstream side circulation flow path 691 and a discharge flow path 692. The upstream side circulation flow path 691, through which the cooling medium is circulated inside the stator 32 in the O axis direction, is connected to the intermediate introduction flow path 662. The discharge flow path 692, through which the cooling medium that circulates inside the stator 32 from the upstream side in the O axis direction is supplied to the heat exchanger 61, is connected to the upstream side circulation flow path 691.

When the upstream side circulation flow path 691 is disposed inside the stator 32, the cooling medium is circulated inside the stator 32. Through the upstream side circulation flow path 691 of this embodiment, the cooling medium is circulated to the upstream side from the downstream side in the O axis direction. The upstream side circulation flow path 691 is a pipe that extends in the O axis direction at a portion close to the rotor 31 in the radial direction inside the stator 32. An end of the upstream side circulation flow path 691 on the downstream side in the O axis direction is connected to the intermediate introduction flow path 662. The upstream side circulation flow path 691 is disposed at the same position in the radial direction as the downstream side circulation flow path 652. The upstream side circulation passage 691 is disposed on the upstream side in the O axis direction relative to the downstream side circulation flow path 652. The upstream side circulation flow path 691 extends to a position on the upstream side in the O axis direction relative to the rotor 31 from the intermediate position in the rotor 31 in the O axis direction inside the stator 32. The upstream side circulation flow path 691 is formed to have the same length as the downstream side circulation flow path 652. The upstream side circulation flow path 691 is integrally formed with the downstream side circulation flow path 652 with respect to the stator 32 and is then formed by sealing a gap between itself and the downstream side circulation flow path 652.

Through the discharge flow path 692, the cooling medium that has circulated in the upstream side circulation flow path 691 and whose temperature has increased is discharged from the inside of the stator 32 to the outside of the casing 5 and is supplied to the heat exchanger 61. The discharge flow path 692 is a pipe that is connected to the heat exchanger 61 from the inside of the stator 32 on the upstream side in the O axis direction of the stator 32. The discharge flow path 692 is connected to an end of the upstream side circulation flow path 691 on the upstream side in the O axis direction.

According to the compressor system 1 described above, a current is supplied to the stator 32 by an external device such as a generator (not shown). A rotating magnetic field is generated based on the supplied current, and the rotor 31 of the motor 3 starts rotating together with the shaft 21. When the shaft 21 rotates at a high speed, in the compressor 2, the impeller 22 that rotates together with the shaft 21 compresses a working fluid flowing into the compressor 2 from the upstream side in the O axis direction and discharges the compressed fluid from the downstream side in the O axis direction.

In the motor 3, the cooling medium cooled by the heat exchanger 61 is introduced into the stator 32 through the introduction flow path 651 and circulates in the downstream side circulation flow path 652. Therefore, a portion close to the rotor 31 on the downstream side in the O axis direction of the stator 32 is cooled. When the portion close to the rotor 31 of the stator 32 is cooled, the temperature of the cooling medium increases. The cooling medium whose temperature has increased is discharged from the downstream side circulation flow path 652 to the outside of the casing 5 through the intermediate discharge flow path 661 and is supplied to and cooled by the heat exchanger 61. The cooling medium cooled by the heat exchanger 61 is introduced again into the stator 32 through the intermediate introduction flow path 662 and circulates in the upstream side circulation flow path 691. Therefore, a portion close to the rotor 31 on the upstream side in the O axis direction relative to the downstream side circulation flow path 652 of the stator 32 is cooled. When the portion close to the rotor 31 of the stator 32 is cooled, the temperature of the cooling medium increases. The cooling medium whose temperature has increased is discharged to the outside of the casing 5 from the upstream side circulation flow path 691 through the discharge flow path 692 and is supplied again to and cooled by the heat exchanger 61. The cooling medium cooled by the heat exchanger 61 is introduced again into the stator 32 through the introduction flow path 651 by the pump 653 and circulates in the downstream side circulation flow path 652. Therefore, the rotor 31 and the stator 32 heated due to heat generated between the rotor 31 and the stator 32 when the rotor 31 rotates can be cooled in two stages in a divided manner in the O axis direction.

The cooling medium that has circulated in the downstream side circulation flow path 652 and the upstream side circulation flow path 691 is cooled by the heat exchanger 61. Therefore, it is possible to efficiently cool the cooling medium to a temperature to which it is possible to sufficiently cool the rotor 31 and the stator 32. That is, when the cooling medium having a temperature to which it is not appropriate to cool the rotor 31 and the stator 32 is cooled by heat exchange with the secondary cooling medium by the heat exchanger 61, it is possible to efficiently decrease the temperature of the cooling medium. The cooling medium that is efficiently cooled by the heat exchanger 61 is circulated in the downstream side circulation flow path 652 and the upstream side circulation flow path 691. Therefore, the cooling medium that can cool the rotor 31 and the stator 32 with high accuracy in the O axis direction can be circulated inside the stator 32. Therefore, the rotor 31 and the stator 32 heated due to heat generated between the rotor 31 and the stator 32 when the rotor 31 rotates can be efficiently cooled in the O axis direction. Therefore, it is possible to suppress the occurrence of a locally high-temperature area in the rotor 31 and the stator 32. As a result, it is possible to suppress a decrease in efficiency of the motor 3 and increase a lifespan.

The cooling medium that has circulated in the downstream side circulation flow path 652 and whose temperature has increased is discharged once to the outside of the casing 5 through the intermediate discharge flow path 661 and can be supplied to the heat exchanger 61. The cooling medium cooled by the heat exchanger 61 through the intermediate introduction flow path 662 can be circulated in the upstream side circulation flow path 691. Therefore, when the cooling medium cooled by the heat exchanger 61 is circulated in the downstream side circulation flow path 652, the downstream side of the rotor 31 and the stator 32 in the O axis direction is reliably cooled and then it is possible to circulate the cooling medium that is newly cooled again by the heat exchanger 61 along the way in the O axis direction in the upstream side circulation flow path 691. As a result, it is also possible to reliably cool the upstream side of the rotor 31 and the stator 32 in the O axis direction. That is, it is possible to prevent an area on the upstream side of the rotor 31 and the stator 32 in the O axis direction from not being sufficiently cooled. Therefore, the cooling mediums cooled by the heat exchanger 61 circulate in the downstream side circulation flow path 652 and the upstream side circulation flow path 691. Therefore, it is possible to suppress temperature irregularity in the O axis direction and cool the rotor 31 and the stator 32. Therefore, it is possible to suppress the occurrence of a locally high-temperature area with high accuracy. As a result, it is possible to suppress a decrease in efficiency of the motor 3 and effectively increase a lifespan.

The intermediate discharge flow path 661 and the intermediate introduction flow path 662 are formed at the intermediate position in the stator 32 in the O axis direction. Therefore, it is possible to cool the rotor 31 and the stator 32 under the same conditions on the upstream side and the downstream side relative to an intermediate position in the O axis direction. As a result, the rotor 31 and the stator 32 are similarly cooled in the O axis direction and it is possible to suppress temperature irregularity in the O axis direction with higher accuracy.

When the cooling flow path 64 is formed in a closed loop flow path, there is no need to provide an additional cooling medium. Therefore, it is possible to decrease a flow rate of the cooling medium that circulates in the cooling flow path 64.

### Second Embodiment

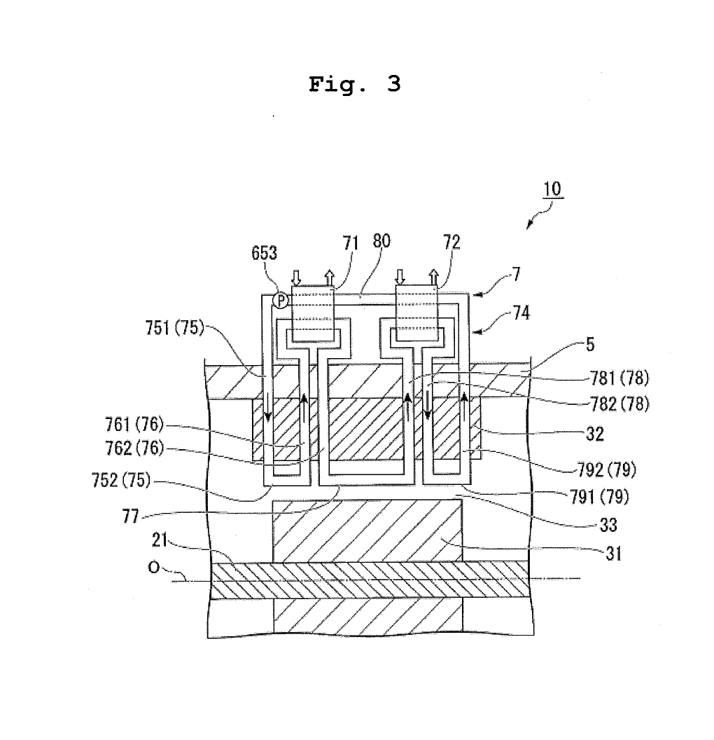

Next, a compressor system 10 according to a second embodiment will be described with reference to FIG. 3.

In the second embodiment, components the same as those in the first embodiment are denoted by the same reference numerals and repeated description thereof will not be given. In the compressor system 10 of the second embodiment, a configuration of the cooling portion is different from that of the first embodiment.

That is, in a cooling portion 7 of the compressor system 10 of the second embodiment, the cooling medium is circulated in the gap 33 (hereinafter simply referred to as the “gap 33”) between the stator 32 and the rotor 31. In addition, in the cooling portion 7, a plurality of heat exchangers and intermediate cooling flow paths are provided in the O axis direction with respect to the stator 32. Specifically, as shown in FIG. 3, the cooling portion 7 of the second embodiment includes a first heat exchanger 71, a second heat exchanger 72, and a cooling flow path 74. The first heat exchanger 71 cools the cooling medium on the downstream side in the O axis direction. The second heat exchanger 72 cools the cooling medium on the upstream side in the O axis direction. Through the cooling flow path 74, the cooling medium that has circulated in the gap 33 is supplied to the first heat exchanger 71 and the second heat exchanger 72. Through the cooling flow path 74, the cooling medium cooled by the first heat exchanger 71 and the second heat exchanger 72 is circulated again in the gap 33.

Note that the gap 33 in this embodiment is a space that is formed between the stator 32 and the rotor 31. The gap 33 is a space interposed between surfaces that face each other in the radial direction, between an outer circumference surface facing outward in the radial direction of the rotor 31 and an inner circumference surface facing inward in the radial direction of the stator 32.

The cooling medium in the cooling portion 7 of the second embodiment and the secondary cooling medium in the first heat exchanger 71 and the second heat exchanger 72 are the same as those in the first embodiment.

As the first heat exchanger 71, the same device as the heat exchanger 61 of the first embodiment is used. The first heat exchanger 71 is disposed outside the casing 5. The second heat exchanger 72 is disposed on the upstream side in the O axis direction relative to the first heat exchanger 71 outside the casing 5. As the second heat exchanger 72, the same device as the heat exchanger 61 and the first heat exchanger 71 of the first embodiment is used.

Through the cooling flow path 74 of the second embodiment, the cooling medium is circulated in the gap 33 and the rotor 31 and the stator 32 are cooled. The cooling flow path 74 of the second embodiment is a closed loop flow path through which the cooling medium is recycled between the first heat exchanger 71 and the second heat exchanger 72, and the motor 3. The cooling flow path 74 includes a downstream side cooling flow path 75, a first intermediate cooling flow path 76, an intermediate circulation flow path 77, a second intermediate cooling flow path 78, an upstream side cooling flow path 79, and a connecting flow path 80. Through the downstream side cooling flow path 75, the cooling medium cooled by the first heat exchanger 71 is circulated in the gap 33 on the downstream side in the O axis direction. Through the first intermediate cooling flow path 76, the cooling medium is supplied from the downstream side cooling flow path 75 to the first heat exchanger 71 along the way in the O axis direction and is returned again to the gap 33. The intermediate circulation flow path 77, through which the cooling medium is circulated in the gap 33 along the way in the O axis direction, is connected to the first intermediate cooling flow path 76. Through the second intermediate cooling flow path 78, the cooling medium is supplied from the first intermediate cooling flow path 76 to the second heat exchanger 72 and is returned again to the gap 33. The upstream side cooling flow path 79, through which the cooling medium is circulated in the gap 33 on the upstream side in the O axis direction, is connected to the second intermediate cooling flow path 78. The connecting flow path 80 connects the first heat exchanger 71 and the second heat exchanger 72.

The downstream side cooling flow path 75 of the second embodiment includes an introduction flow path 751 and a downstream side circulation flow path 752. Through the introduction flow path 751, the cooling medium is introduced into the gap 33 from the first heat exchanger 71 on the downstream side in the O axis direction. The downstream side circulation flow path 752 is connected to the introduction flow path 751 and extends in the O axis direction in the gap 33.

Through the introduction flow path 751 of the second embodiment, the cooling medium cooled by the first heat exchanger 71 is introduced into the gap 33. The introduction flow path 751 is a pipe that is connected to the gap 33 from the heat exchanger 61 on the downstream side in the O axis direction. The pump 653 configured to pressure-feed a cooling medium is provided along the introduction flow path 751.

When the downstream side circulation flow path 752 of the second embodiment is disposed in the gap 33, the cooling medium is circulated in the gap 33. Through the downstream side circulation flow path 752 of this embodiment, the cooling medium is circulated from the downstream side to the upstream side in the O axis direction. The downstream side circulation flow path 752 is a pipe that extends in the O axis direction in the gap 33. An end of the downstream side circulation flow path 752 on the downstream side in the O axis direction is connected to the introduction flow path 751. The downstream side circulation flow path 752 is formed to have a length of about one third of the length of the rotor 31 in the O axis direction from a position on the downstream side in the O axis direction relative to the rotor 31.

Through the first intermediate cooling flow path 76, along the way in the O axis direction of the gap 33, the cooling medium that circulates in the gap 33 is supplied to the first heat exchanger 71. Through the first intermediate cooling flow path 76, along the way in the O axis direction of the gap 33, the cooling medium cooled by the first heat exchanger 71 flows again into the gap 33. The first intermediate cooling flow path 76 is formed along the way in the O axis direction of the gap 33. The first intermediate cooling flow path 76 includes a first intermediate discharge flow path 761 and a first intermediate introduction flow path 762. Through the first intermediate discharge flow path 761, the cooling medium is discharged from the gap 33 along the way in the O axis direction of the gap 33 and is supplied to the first heat exchanger 71. Through the first intermediate introduction flow path 762, the cooling medium is introduced into the gap 33 from the first heat exchanger 71 along the way in the O axis direction of the gap 33.

Through the first intermediate discharge flow path 761, the cooling medium that has circulated in the downstream side circulation flow path 752 and whose temperature has increased is discharged from the gap 33 to the outside of the casing 5 and is supplied to the first heat exchanger 71. The first intermediate discharge flow path 761 is a pipe that is connected to the first heat exchanger 71 from an end of the downstream side circulation flow path 752 on the upstream side in the O axis direction.

Through the first intermediate introduction flow path 762, the cooling medium cooled by the first heat exchanger 71 is introduced again from the outside of the casing 5 into the gap 33. The first intermediate introduction flow path 762 is a pipe that is connected to the intermediate circulation flow path 77 from the heat exchanger 61. The first intermediate introduction flow path 762 is disposed at an interval from the first intermediate discharge flow path 761 by the side on the upstream side in the O axis direction inside the stator 32. The first intermediate introduction flow path 762 is formed to have the same length as the first intermediate discharge flow path 761.

When the intermediate circulation flow path 77 is disposed in the gap 33, the cooling medium is circulated in the gap 33. Through the intermediate circulation flow path 77 of this embodiment, the cooling medium is circulated from the downstream side to the upstream side in the O axis direction. The intermediate circulation flow path 77 is a pipe that extends in the O axis direction in the gap 33. An end of the intermediate circulation flow path 77 on the downstream side in the O axis direction is connected to the first intermediate introduction flow path 762. The intermediate circulation flow path 77 is disposed on the upstream side in the O axis direction relative to the downstream side circulation flow path 752 in the gap 33. The intermediate circulation flow path 77 is formed to have a length of about one third of the length of the rotor 31 in the O axis direction. That is, the intermediate circulation flow path 77 is formed to have the same length as the downstream side circulation flow path 752.

Through the second intermediate cooling flow path 78, along the way in the O axis direction of the gap 33, the cooling medium that circulates in the gap 33 is supplied to the second heat exchanger 72. Through the second intermediate cooling flow path 78, along the way in the O axis direction of the gap 33, the cooling medium cooled by the second heat exchanger 72 flows again into the gap 33. The second intermediate cooling flow path 78 is formed on the upstream side in the O axis direction relative to the first intermediate cooling flow path 76 along the way in the O axis direction of the gap 33. The second intermediate cooling flow path 78 includes a second intermediate discharge flow path 781 and a second intermediate introduction flow path 782. Through the second intermediate discharge flow path 781, the cooling medium is discharged from the gap 33 along the way in the O axis direction of the gap 33 and is supplied to the second heat exchanger 72. Through the second intermediate introduction flow path 782, the cooling medium is introduced into the gap 33 from the second heat exchanger 72 along the way in the O axis direction of the gap 33.

Through the second intermediate discharge flow path 781, the cooling medium that has circulated in the intermediate circulation flow path 77 and whose temperature has increased is discharged from the gap 33 to the outside of the casing 5 and is supplied to the second heat exchanger 72. The second intermediate discharge flow path 781 is a pipe that is connected to the second heat exchanger 72 from an end of the intermediate circulation flow path 77 on the upstream side in the O axis direction. That is, the second intermediate discharge flow path 781 is disposed on the upstream side in the O axis direction relative to the first intermediate introduction flow path 762.

Through the second intermediate introduction flow path 782, the cooling medium cooled by the second heat exchanger 72 is introduced again into the gap 33. The second intermediate introduction flow path 782 is a pipe that is connected to the upstream side cooling flow path 79 from the second heat exchanger 72. The second intermediate introduction flow path 782 is disposed at an interval from the second intermediate discharge flow path 781 by the side on the upstream side in the O axis direction inside the stator 32. The second intermediate introduction flow path 782 is formed to have the same length as the second intermediate discharge flow path 781.

The upstream side cooling flow path 79 includes an upstream side circulation flow path 791 and a discharge flow path 792. The upstream side circulation flow path 791 is connected to the second intermediate introduction flow path 782 and extends in the O axis direction in the gap 33. The discharge flow path 792, through which the cooling medium that circulates in the gap 33 is supplied to the second heat exchanger 72 from the upstream side in the O axis direction, is connected to the upstream side circulation flow path 791.

When the upstream side circulation flow path 791 is disposed in the gap 33, the cooling medium is circulated in the gap 33. Through the upstream side circulation flow path 791 of this embodiment, the cooling medium is circulated from the downstream side to the upstream side in the O axis direction. The upstream side circulation flow path 791 is a pipe that extends in the O axis direction in the gap 33. An end of the upstream side circulation flow path 791 on the downstream side in the O axis direction is connected to the second intermediate introduction flow path 782. An end of the upstream side circulation flow path 791 on the upstream side is connected to the discharge flow path 792. The upstream side circulation flow path 791 is disposed at the same position in the radial direction as the downstream side circulation flow path 752 and the intermediate circulation flow path 77. The upstream side circulation flow path 791 is disposed on the upstream side in the O axis direction relative to the intermediate circulation flow path 77. The upstream side circulation flow path 791 is formed to have a length of about one third of the length of the rotor 31 in the O axis direction. That is, the upstream side circulation flow path 791 is formed to have the same length as the downstream side circulation flow path 752 and the intermediate circulation flow path 77.

Through the discharge flow path 792, the cooling medium that has circulated in the upstream side circulation flow path 791 and whose temperature has increased is discharged from the gap 33 to the outside of the casing 5 and is supplied to the second heat exchanger 72. The discharge flow path 792 is a pipe that is connected to the second heat exchanger 72 from the inside of the stator 32 on the upstream side in the O axis direction of the stator 32. The discharge flow path 792 is connected to an end of the upstream side circulation flow path 791 on the upstream side in the O axis direction.

Through the connecting flow path 80, the cooling medium cooled by the second heat exchanger 72 is supplied to the first heat exchanger 71. The connecting flow path 80 is a pipe that connects the first heat exchanger 71 and the second heat exchanger 72 outside the casing 5.

According to the compressor system 10 of the second embodiment, the cooling medium cooled by the first heat exchanger 71 is introduced into the gap 33 through the introduction flow path 751 and circulates in the downstream side circulation flow path 752. Therefore, the vicinity of the gap 33 on the downstream side in the O axis direction is cooled. When the vicinity of the gap 33 on the downstream side in the O axis direction is cooled, the temperature of the cooling medium increases. The cooling medium whose temperature has increased is discharged to the outside of the casing 5 from the downstream side circulation flow path 752 through the first intermediate discharge flow path 761 and is supplied to and cooled by the first heat exchanger 71. The cooling medium cooled by the first heat exchanger 71 is introduced again into the gap 33 through the first intermediate introduction flow path 762 and circulates in the intermediate circulation flow path 77. Therefore, the vicinity around the middle of the gap 33 in the O axis direction that is on the upstream side in the O axis direction relative to the downstream side circulation flow path 752 is cooled. When the vicinity around the middle of the gap 33 in the O axis direction is cooled, the temperature of the cooling medium increases. The cooling medium whose temperature has increased is discharged to the outside of the casing 5 from the intermediate circulation flow path 77 through the second intermediate discharge flow path 781 and is supplied to and cooled by the second heat exchanger 72. The cooling medium cooled by the second heat exchanger 72 is introduced again into the gap 33 through the second intermediate introduction flow path 782 and circulates in the upstream side circulation flow path 791. Therefore, the vicinity of the gap 33 on the upstream side in the O axis direction that is on the upstream side in the O axis direction relative to the intermediate circulation flow path 77 is cooled. When the vicinity of the gap 33 on the upstream side in the O axis direction is cooled, the temperature of the cooling medium increases. The cooling medium whose temperature has increased is discharged to the outside of the casing 5 from the upstream side circulation flow path 791 through the discharge flow path 792 and is supplied again to and cooled by the second heat exchanger 72. The cooling medium cooled by the second heat exchanger 72 circulates in the connecting flow path 80, is supplied to the first heat exchanger 71, and is additionally cooled. The cooling medium cooled by the first heat exchanger 71 is introduced again into the stator 32 through the introduction flow path 751 by the pump 653 and circulates in the downstream side circulation flow path 752. Therefore, the rotor 31 and the stator 32 heated due to heat generated between the rotor 31 and the stator 32 can be cooled in three stages in a divided manner in the O axis direction.

The first intermediate cooling flow path 76 and the second intermediate cooling flow path 78 are included. Therefore, the cooling medium whose temperature has increased can be cooled again by the first heat exchanger 71 and the second heat exchanger 72 at a plurality of locations in the O axis direction with respect to the gap 33. Therefore, the cooling medium that is newly cooled can be circulated in two locations in the O axis direction in the gap 33. Therefore, it is possible to further improve cooling efficiency of the rotor 31 and the stator 32 in the O axis direction.

The downstream side circulation flow path 752, the intermediate circulation flow path 77, and the upstream side circulation flow path 791 are included. Therefore, the cooling medium can be circulated in the gap 33. Therefore, compared to when the cooling medium is circulated inside the stator 32, the cooling medium can be circulated at a position closer to the rotor 31. Therefore, it is possible to improve cooling efficiency of the rotor 31.

The first embodiment and the second embodiment of the present invention have been described in detail above with reference to the drawings, but configurations and combinations thereof in the embodiments are only examples, and additions, omissions, substitutions and other modifications of the configurations can be made without departing from the scope of the present invention. In addition, the present invention is not limited to the first embodiment and the second embodiment and is only limited by the scope of the appended claims.

In addition, the heat exchanger is not limited to a heat exchanger disposed outside the casing 5 as in this embodiment and a heat exchanger that can cool the cooling medium may be provided at any position. For example, the heat exchanger 61, the first heat exchanger 71, and the second heat exchanger 72 may be disposed inside the casing 5.

In the first embodiment, the number of heat exchangers 61 is not limited to one. As in the second embodiment, two, three or more heat exchangers 61 may be provided.

A position of the intermediate cooling flow path is not limited to the intermediate position in the stator 32 as in the intermediate cooling flow path 66 of the first embodiment and the intermediate cooling flow paths are not limited to the first intermediate cooling flow path 76 and the second intermediate cooling flow path 78 of the second embodiment that are evenly disposed. The intermediate cooling flow paths may be unevenly disposed with respect to the stator 32 according to a location at which cooling is necessary. The number of intermediate cooling flow paths is not limited to two as in the second embodiment, and three or more intermediate cooling flow paths may be provided.

### Third Embodiment

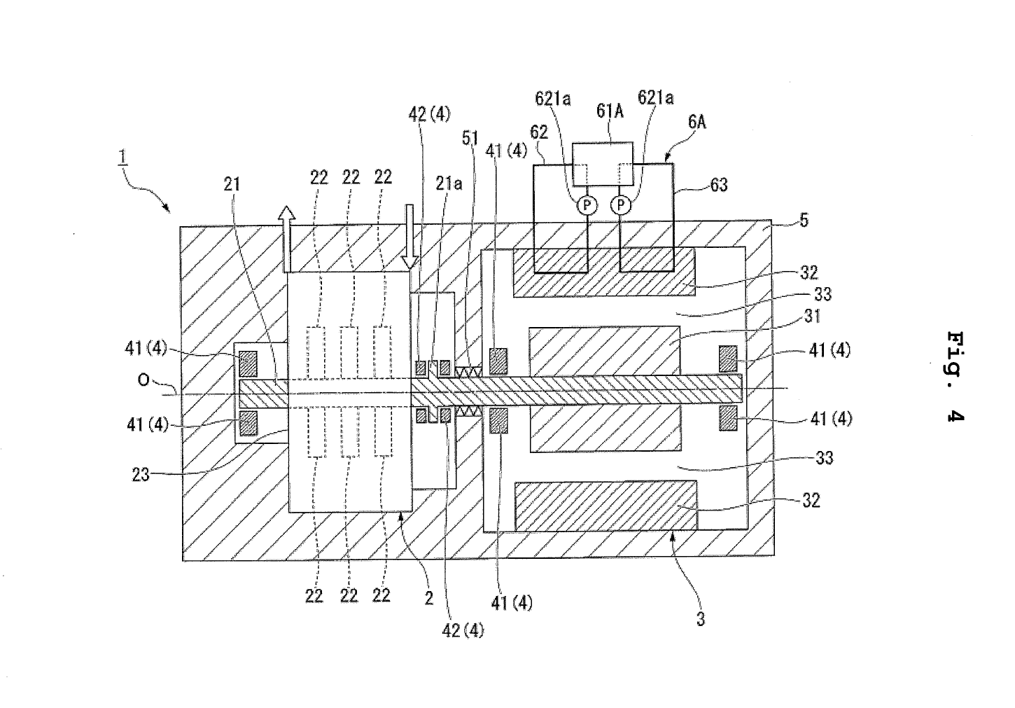

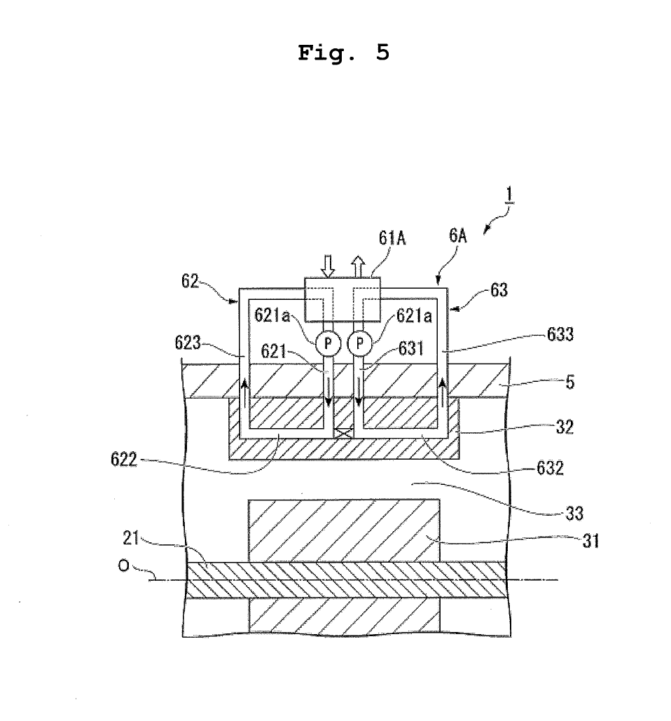

Next, a compressor system according to a third embodiment will be described with reference to FIG. 4 and FIG. 5.

In the third embodiment, the same components as those in the first embodiment and the second embodiment are denoted by the same reference numerals and the descriptions thereof will not be described. In the compressor system 10 of the third embodiment, a configuration of the cooling portion is different from that of the first embodiment.

That is, the cooling portion 6A of the third embodiment cools the rotor 31 and the stator 32. As shown in FIG. 4 and FIG. 5, the cooling portion 6A of this embodiment includes a heat exchanger 61A, a first internal flow path (a first flow path) 62, and a second internal flow path (a second flow path) 63. The heat exchanger 61A cools the cooling medium that has circulated inside the stator 32. Through the first internal flow path 62, the cooling medium that has circulated inside the stator 32 is recycled and is circulated again inside the stator 32. The second internal flow path 63 is adjacent to the first internal flow path 62 at an interval therefrom in the O axis direction. Through the second internal flow path 63, the cooling medium that has circulated inside the stator 32 is recycled and is circulated again inside the stator 32.

As the cooling medium, for example, a gas such as air and helium is preferably used. When a gas such as air and helium is used, compared to a gas including a large amount of liquid content such as a liquid and water vapor, it is possible to suppress a decrease in the strength of metal materials forming the heat exchanger 61A, the first internal flow path 62, and the second internal flow path 63 due to oxidation.

As the cooling medium, a part of the compressed fluid compressed by the compressor 2 may be extracted and used. When the compressed fluid of the compressor 2 is used as the cooling medium, without using a device configured to send a cooling medium such as a pump 621a, the cooling medium can be circulated in the first internal flow path 62 and the second internal flow path 63. Therefore, it is possible to form the first internal flow path 62 and the second internal flow path 63 with a simple configuration.

The heat exchanger 61A cools the cooling medium that has circulated inside the stator 32 through the first internal flow path 62 and the second internal flow path 63 and is heated to a high temperature. The heat exchanger 61A of this embodiment is disposed outside the casing 5. The heat exchanger 61A exchanges heat between the surrounding secondary cooling medium and the cooling medium. Therefore, the heat exchanger 61A cools the cooling medium to a temperature to which it is appropriate to cool the motor 3. The heat exchanger 61A cools the cooling medium that circulates in the first internal flow path 62 and cools the cooling medium that circulates in the second internal flow path 63. That is, in this embodiment, only one heat exchanger 61A is provided for the first internal flow path 62 and the second internal flow path 63.

When the compressor system 1 is used for the subsea production system and is provided in the seabed, the surrounding seawater is preferably used as the secondary cooling medium. When the surrounding seawater is used, there is no need to provide an additional secondary cooling medium for the heat exchanger 61A. When the surrounding seawater is used, it is possible to cool the cooling medium to a temperature to which it is possible to sufficiently cool the motor 3 by simply exchanging heat with low temperature seawater in the seabed.

When the compressor system 1 is used for FPSO and is provided in a marine facility such as a ship, the surrounding air or fresh water stored in the marine facility is preferably used as the secondary cooling medium. When the surrounding air or fresh water is used, there is no need to provide an additional secondary cooling medium for the heat exchanger 61A. When the surrounding air or fresh water is used, it is possible to cool the cooling medium to a temperature to which it is possible to sufficiently cool the motor 3 while suppressing the occurrence of an event such as corrosion of a pipe.

Through the first internal flow path 62, the cooling medium is circulated inside the stator 32 and cools the rotor 31 and the stator 32. The first internal flow path 62 of this embodiment is a closed loop flow path through which the cooling medium is recycled between the heat exchanger 61A and the motor 3. The first internal flow path 62 is disposed on a downstream side relative to a center position in the stator 32 in the O axis direction.

Here, a side on which the compressor 2 is disposed with respect to the motor 3 in the O axis direction is defined as a downstream side (the left side in FIG. 4) that is one side in the O axis direction. A side opposite to the downstream side is defined as an upstream side (the right side in FIG. 4) that is the other side in the O axis direction.

Through the first internal flow path 62 of this embodiment, the cooling medium is circulated to the downstream side from the upstream side in the O axis direction inside the stator 32. The first internal flow path 62 includes a first internal introduction flow path 621, a first internal circulation flow path 622, and a first internal discharge flow path 623. Through the first internal introduction flow path 621, the cooling medium cooled by the heat exchanger 61A is introduced into the stator 32 along the way in the O axis direction. The first internal circulation flow path 622, through which the cooling medium is circulated inside the stator 32 in the O axis direction, is connected to the first internal introduction flow path 621. The first internal discharge flow path 623, through which the cooling medium is discharged from the inside of the stator 32 and is supplied to the heat exchanger 61A, is connected to the first internal circulation flow path 622.

Through the first internal introduction flow path 621, the cooling medium cooled by the heat exchanger 61A is introduced into the stator 32 from the outside of the casing 5. The first internal introduction flow path 621 is a pipe that is connected to the inside of the stator 32 from the heat exchanger 61A at the intermediate position in the stator 32 in the O axis direction. The pump 621a configured to pressure-feed a cooling medium is provided along the first internal introduction flow path 621.

When the first internal circulation flow path 622 is disposed inside the stator 32, the cooling medium is circulated inside the stator 32. Through the first internal circulation flow path 622 of this embodiment, the cooling medium is circulated to the downstream side from the upstream side in the O axis direction. The first internal circulation flow path 622 is a pipe that extends in the O axis direction at a portion close to the rotor 31 in the radial direction inside the stator 32. The first internal circulation flow path 622 extends to a position on the downstream side in the O axis direction relative to the rotor 31 from the intermediate position in the rotor 31 in the O axis direction inside the stator 32. An end of the first internal circulation flow path 622 on the upstream side in the O axis direction is connected to the first internal introduction flow path 621.

Through the first internal discharge flow path 623, the cooling medium that has circulated in the first internal circulation flow path 622 and whose temperature has increased is discharged to the outside of the casing 5 from the stator 32 and is supplied to the heat exchanger 61A. The first internal discharge flow path 623 is a pipe that is connected to the heat exchanger 61A from the first internal circulation flow path 622 on the downstream side in the O axis direction of the stator 32. The first internal discharge flow path 623 is connected to an end of the first internal circulation flow path 622 on the downstream side in the O axis direction.

Through the second internal flow path 63, the cooling medium is circulated inside the stator 32 on the upstream side in the O axis direction relative to the first internal flow path 62 and cools the rotor 31 and the stator 32. The second internal flow path 63 of this embodiment is a closed loop flow path through which the cooling medium is recycled between the heat exchanger 61A and the motor 3 and is independent of the first internal flow path 62. The second internal flow path 63 is disposed at an interval from the first internal flow path 62 in the O axis direction. The second internal flow path 63 is disposed on the upstream side relative to the center position in the stator 32 in the O axis direction. The second internal flow path 63 is formed to have a flow path length that is the same as the length of the first internal flow path 62.

In a second internal circulation flow path 632 of this embodiment, a circulation direction of the cooling medium is opposite to that of the first internal flow path 62. Through the second internal circulation flow path 632, the cooling medium is circulated from the downstream side to the upstream side in the O axis direction inside the stator 32. The second internal flow path 63 includes a second internal introduction flow path 631, the second internal circulation flow path 632, and a second internal discharge flow path 633. Through the second internal introduction flow path 631, the cooling medium cooled by the heat exchanger 61A is introduced into the stator 32 along the way in the O axis direction. The second internal circulation flow path 632, through which the cooling medium is circulated inside the stator 32 in the O axis direction, is connected to the second internal introduction flow path 631. The second internal discharge flow path 633, through which the cooling medium is discharged from the inside of the stator 32 and is supplied to the heat exchanger 61A, is connected to the second internal circulation flow path 632.

Through the second internal introduction flow path 631, the cooling medium cooled by the heat exchanger 61A is introduced into the stator 32 from the outside of the casing 5. The second internal introduction flow path 631 is a pipe that is connected to the inside of the stator 32 from the heat exchanger 61A at the intermediate position in the stator 32 in the O axis direction. The second internal introduction flow path 631 is disposed at an interval from the first internal introduction flow path 621 on the upstream side in the O axis direction. Similarly to the first internal introduction flow path 621, the pump 621a configured to pressure-feed a cooling medium is provided along the second internal introduction flow path 631. The second internal introduction flow path 631 is formed to have the same length as the first internal introduction flow path 621.

When the second internal circulation flow path 632 is disposed inside the stator 32, the cooling medium is circulated inside the stator 32. Through the second internal circulation flow path 632 of this embodiment, the cooling medium is circulated from the downstream side to the upstream side in the O axis direction. The second internal circulation flow path 632 is a pipe that extends in the O axis direction at a portion close to the rotor 31 in the radial direction inside the stator 32. An end of the second internal circulation flow path 632 on the downstream side in the O axis direction is connected to the second internal introduction flow path 631. The second internal circulation flow path 632 extends to a position on the upstream side in the O axis direction relative to the rotor 31 from the intermediate position in the rotor 31 in the O axis direction inside the stator 32. That is, the second internal circulation flow path 632 extends to a side opposite to the first internal circulation flow path 622 in the O axis direction. The second internal circulation flow path 632 is disposed at the same position in the radial direction as the first internal circulation flow path 622. The second internal circulation passage 632 is formed to have the same length as the first internal circulation flow path 622. The second internal circulation flow path 632 is integrally formed with the first internal circulation flow path 622 with respect to the stator 32 and is then formed by sealing a gap between itself and the first internal circulation flow path 622.

Through the second internal discharge flow path 633, the cooling medium that has circulated in the second internal circulation flow path 632 and whose temperature has increased is discharged to the outside of the casing 5 from the inside of the stator 32 and is supplied to the heat exchanger 61A. The second internal discharge flow path 633 is a pipe that is connected to the heat exchanger 61A from the second internal circulation flow path 632 on the upstream side in the O axis direction of the stator 32. The second internal discharge flow path 633 is connected to an end of the second internal circulation flow path 632 on the upstream side in the O axis direction. The second internal discharge flow path 633 is formed to have the same length as the first internal discharge flow path 623.

According to the compressor system 1 described above, a current is supplied to the stator 32 by an external device such as a generator (not shown). A rotating magnetic field is generated based on the supplied current, and the rotor 31 of the motor 3 starts rotating together with the shaft 21. When the shaft 21 rotates at a high speed, in the compressor 2, the impeller 22 that rotates together with the shaft 21 compresses a working fluid flowing into the compressor 2 from the upstream side in the O axis direction and discharges the compressed fluid from the downstream side in the O axis direction.

In the motor 3, the cooling medium cooled by the heat exchanger 61A is introduced into the stator 32 through the first internal introduction flow path 621 and circulates in the first internal circulation flow path 622. Therefore, a portion close to the rotor 31 on the downstream side in the O axis direction of the stator 32 is cooled. When the portion close to the rotor 31 of the stator 32 is cooled, the temperature of the cooling medium increases. The cooling medium whose temperature has increased is discharged to the outside of the casing 5 from the first internal circulation flow path 622 through the first internal discharge flow path 623 and is supplied to and cooled by the heat exchanger 61A. The cooling medium cooled by the heat exchanger 61A is introduced again into the stator 32 through the first internal introduction flow path 621 by the pump 621a and circulates in the first internal circulation flow path 622.

At the same time, the cooling medium cooled by the heat exchanger 61A is introduced into the stator 32 through the second internal introduction flow path 631 and circulates in the second internal circulation flow path 632. Therefore, a portion close to the rotor 31 on the upstream side in the O axis direction relative to the first internal circulation flow path 622 of the stator 32 is cooled. When the portion close to the rotor 31 of the stator 32 is cooled, the temperature of the cooling medium increases. The cooling medium whose temperature has increased is discharged to the outside of the casing 5 from the second internal circulation flow path 632 through the second internal discharge flow path 633 and is supplied to and cooled by the heat exchanger 61A. The cooling medium cooled by the heat exchanger 61A is introduced again into the stator 32 through the second internal introduction flow path 631 by the pump 621a and circulates in the second internal circulation flow path 632.

Therefore, while the rotor 31 and the stator 32 on the downstream side in the O axis direction are cooled by the cooling medium that circulates in the first internal circulation flow path 622, the rotor 31 and the stator 32 on the upstream side in the O axis direction can be cooled by the cooling medium that circulates in the second internal circulation flow path 632 at the same time. Therefore, through the first internal circulation flow path 622 and the second internal circulation flow path 632, the rotor 31 and the stator 32 that are elongated in the O axis direction can be separately cooled in short divided sections which are an area on the downstream side and an area on the upstream side in the O axis direction. For example, when the entire areas of the rotor 31 and the stator 32 in the O axis direction are cooled, if the rotor 31 and the stator 32 on the downstream side in the O axis direction are cooled, the temperature of the cooling medium increases. As a result, there is a possibility of the upstream side in the O axis direction not being sufficiently cooled. However, in this embodiment, an area to be cooled is divided into short sections in the O axis direction, and the rotor 31 and the stator 32 are cooled by a cooling medium that circulates in another system. Therefore, it is possible to prevent the occurrence of an area that is not sufficiently cooled. Therefore, the rotor 31 and the stator 32 heated due to heat generated between the rotor 31 and the stator 32 when the rotor 31 rotates can be efficiently cooled in the O axis direction. Therefore, it is possible to suppress the occurrence of a locally high-temperature area in the rotor 31 and the stator 32. As a result, it is possible to suppress a decrease in efficiency of the motor 3 and increase a lifespan.

The cooling medium that has circulated in the first internal circulation flow path 622 and the second internal circulation flow path 632 is cooled by the heat exchanger 61A. Therefore, it is possible to efficiently cool the cooling medium to a temperature to which it is possible to sufficiently cool the rotor 31 and the stator 32. That is, a cooling medium having a temperature to which it is not suitable for cooling the rotor 31 and the stator 32 can be cooled through heat exchange with the secondary cooling medium by the heat exchanger 61A. Therefore, it is possible to efficiently decrease the temperature of the cooling medium. The cooling medium that is efficiently cooled by the heat exchanger 61A is circulated in the first internal circulation flow path 622 and the second internal circulation flow path 632. As a result, the cooling medium that can cool the rotor 31 and the stator 32 with high accuracy in the O axis direction can be circulated inside the stator 32. Therefore, the rotor 31 and the stator 32 heated due to heat generated between the rotor 31 and the stator 32 when the rotor 31 rotates can be efficiently cooled in the O axis direction. Therefore, it is possible to suppress the occurrence of a locally high-temperature area in the rotor 31 and the stator 32. As a result, it is possible to suppress a decrease in efficiency of the motor 3 and increase a lifespan.

When only one heat exchanger 61A is provided for the first internal flow path 62 and the second internal flow path 63 in common, it is possible to configure the first internal flow path 62 and the second internal flow path 63 with fewer components.

Directions in which the cooling mediums circulate in the first internal flow path 62 and the second internal flow path 63 are opposite to each other. Therefore, circulation directions of the cooling mediums that circulate in flow paths that extend in the radial direction like the first internal introduction flow path 621 and the second internal introduction flow path 631 that are disposed at intermediate positions in the O axis direction closest in the O axis direction can be set to be the same. Therefore, it is possible to suppress an effect occurring due to heat exchange between cooling mediums that circulate in flow paths formed at positions close to each other in the O axis direction. In particular, as in this embodiment, when the first internal flow path 62 and the second internal flow path 63 are formed to have the same length and temperature conditions for a fluid that circulates therein are the same, it is possible to suppress an influence of heat exchange more effectively.

In addition, in this embodiment, the first internal circulation flow path 622 and the first internal circulation flow path 622 are sealed and the first internal flow path 62 and the second internal flow path 63 are separately formed. However, when directions in which the cooling medium circulates are opposite to each other, the first internal flow path 62 and the second internal flow path 63 may be integrally formed. This is so that, when directions in which the cooling medium circulates are set to be opposite to each other, like the first internal introduction flow path 621 and the second internal introduction flow path 631, circulation directions of the cooling mediums that circulate in flow paths that are formed at positions close to each other in the O axis direction that extend in the radial direction are the same. Therefore, it is possible to form the first internal flow path 62 and the second internal flow path 63 through a fewer number of processes.

When the first internal flow path 62 and the second internal flow path 63 are formed in a closed loop flow path, there is no need to provide an additional cooling medium. Therefore, it is possible to decrease a flow rate of the cooling medium that circulates in the first internal flow path 62 and the second internal flow path 63.

### Fourth Embodiment

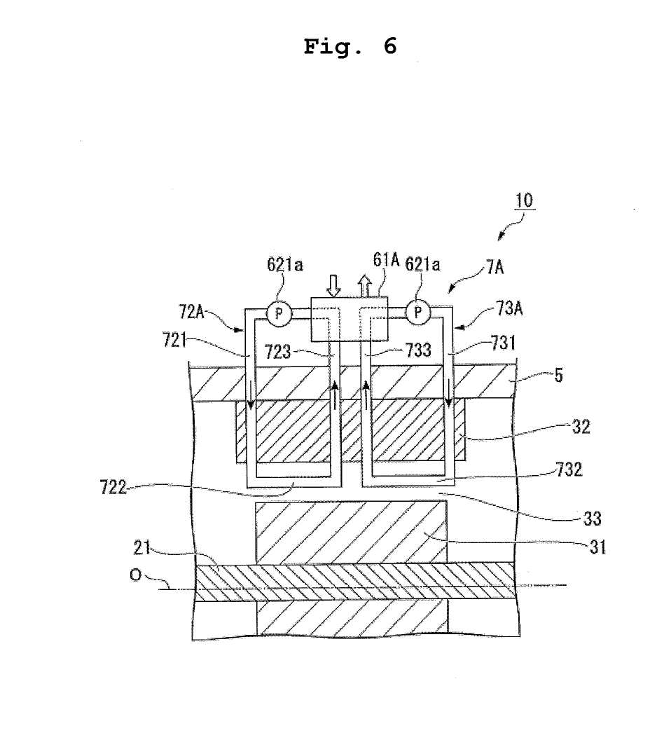

Next, a compressor system 10 according to a fourth embodiment will be described with reference to FIG. 6.

In the fourth embodiment, the same components as those in the first embodiment to the third embodiment are denoted by the same reference numerals and the descriptions thereof will not be described. In the compressor system 10 of the fourth embodiment, a configuration of the cooling portion 7 is different from those of the first embodiment to the third embodiment.

That is, in a cooling portion 7A of the compressor system 10 of the fourth embodiment, the cooling medium is circulated in the gap 33 (hereinafter simply referred to as the “gap 33”) between the stator 32 and the rotor 31. In addition, the circulation direction of the cooling medium that circulates in the first flow path and the second flow path is different from that of the first embodiment. Specifically, as shown in FIG. 6, the cooling portion 7A of the second embodiment includes the same heat exchanger 61A as in the third embodiment, a first gap flow path (a first flow path) 72A and a second gap flow path (a second flow path) 73A. Through the first gap flow path 72A, the cooling medium that has circulated in the gap 33 formed between the stator 32 and the rotor 31 is recycled and is circulated again in the gap 33. The second gap flow path 73A is adjacent to the first gap flow path 72A at an interval therefrom in the O axis direction. Through the second gap flow path 73A, the cooling medium that has circulated in the gap 33 is recycled and is circulated again in the gap 33.

Note that the gap 33 in this embodiment is a space that is formed between the stator 32 and the rotor 31. The gap 33 is a space interposed between surfaces that face each other in the radial direction, between an outer circumference surface facing outward in the radial direction of the rotor 31 and an inner circumference surface facing inward in the radial direction of the stator 32.

Through the first gap flow path 72A, the cooling medium is circulated in the gap 33, and the rotor 31 and the stator 32 are cooled. The first gap flow path 72A is a closed loop flow path through which the cooling medium is recycled between the heat exchanger 61A and the motor 3. The first gap flow path 72A is disposed on the downstream side relative to the center position in the stator 32 in the O axis direction. Through the first gap flow path 72A, the cooling medium is circulated to the upstream side from the downstream side in the O axis direction in the gap 33. The first gap flow path 72A includes a first gap introduction flow path 721, a first gap circulation flow path 722, and a first gap discharge flow path 723. Through the first gap introduction flow path 721, the cooling medium cooled by the heat exchanger 61A is introduced into the gap 33 along the way in the O axis direction. The first gap circulation flow path 722, through which the cooling medium is circulated in the gap 33 in the O axis direction, is connected to the first gap introduction flow path 721. The first gap discharge flow path 723, through which the cooling medium is discharged from the gap 33 and is supplied to the heat exchanger 61A, is connected to the first gap circulation flow path 722.

Through the first gap introduction flow path 721, the cooling medium cooled by the heat exchanger 61A is introduced into the gap 33 from the outside of the casing 5. The first gap introduction flow path 721 is a pipe that is connected to the gap 33 from the heat exchanger 61A on the downstream side in the O axis direction of the stator 32. The pump 621a configured to pressure-feed a cooling medium is provided along the first gap introduction flow path 721.

When the first gap circulation flow path 722 is disposed in the gap 33, the cooling medium is circulated in the gap 33. Through the first gap circulation flow path 722 of this embodiment, the cooling medium is circulated to the upstream side from the downstream side in the O axis direction. The first gap circulation flow path 722 is a pipe that extends in the O axis direction in the gap 33. The first gap circulation flow path 722 extends to a position on the downstream side in the O axis direction relative to the rotor 31 from the intermediate position in the rotor 31 in the O axis direction in the gap 33. An end of the first gap circulation flow path 722 on the downstream side in the O axis direction is connected to the first gap introduction flow path 721.

Through the first gap discharge flow path 723, the cooling medium that has circulated in the first gap circulation flow path 722 and whose temperature has increased is discharged from the gap 33 to the outside of the casing 5 and is supplied to the heat exchanger 61A. The first gap discharge flow path 723 is a pipe that is connected to the heat exchanger 61A from the first gap circulation flow path 722 at the intermediate position in the stator 32 in the O axis direction. The first gap discharge flow path 723 is connected to an end of the first gap circulation flow path 722 on the upstream side in the O axis direction.

Through the second gap flow path 73A, the cooling medium is circulated in the gap 33 on the upstream side in the O axis direction relative to the first gap flow path 72A and cools the rotor 31 and the stator 32. The second gap flow path 73A of this embodiment is a closed loop flow path through which the cooling medium is recycled between the heat exchanger 61A and the motor 3 and is independent of the first gap flow path 72A. The second gap flow path 73A is disposed at an interval from the first gap flow path 72A in the O axis direction. The second gap flow path 73A is disposed on the upstream side relative to the center position in the stator 32 in the O axis direction.

In the second gap flow path 73A of this embodiment, a circulation direction of the cooling medium is opposite to that of the first gap flow path 72A. Through the second gap flow path 73A, the cooling medium is circulated to the downstream side from the upstream side in the gap 33 in the O axis direction. The second gap flow path 73A includes a second gap introduction flow path 731, a second gap circulation flow path 732, and a second gap discharge flow path 733. Through the second gap introduction flow path 731, the cooling medium cooled by the heat exchanger 61A is introduced into the gap 33 from the upstream side in the O axis direction. The second gap circulation flow path 732, through which the cooling medium is circulated in the gap 33 in the O axis direction, is connected to the second gap introduction flow path 731. The second gap discharge flow path 733, through which the cooling medium is discharged from the gap 33 and is supplied to the heat exchanger 61A, is connected to the second gap circulation flow path 732. The second gap flow path 73A is formed to have a flow path length that is the same as the length of the first gap flow path 72A.

Through the second gap introduction flow path 731, the cooling medium cooled by the heat exchanger 61A is introduced into the gap 33 from the outside of the casing 5. The second gap introduction flow path 731 is a pipe that is connected to the gap 33 from the heat exchanger 61A on the upstream side in the O axis direction of the stator 32. Similarly to the first gap introduction flow path 721, the pump 621a configured to pressure-feed a cooling medium is provided along the second gap introduction flow path 731.

When the second gap circulation flow path 732 is disposed in the gap 33, the cooling medium is circulated in the gap 33. Through the second gap circulation flow path 732 of this embodiment, the cooling medium is circulated to the downstream side from the upstream side in the O axis direction. The second gap circulation flow path 732 is a pipe that extends in the gap 33 in the O axis direction. An end of the second gap circulation flow path 732 on the upstream side in the O axis direction is connected to the second gap introduction flow path 731. The second gap circulation flow path 732 extends to a position on the upstream side in the O axis direction relative to the rotor 31 from the intermediate position in the rotor 31 in the O axis direction in the gap 33. That is, the second gap circulation flow path 732 extends to a side opposite to the first gap circulation flow path 722 in the O axis direction. The second gap circulation flow path 732 is disposed at the same position in the radial direction as the first gap circulation flow path 722. The second gap circulation flow path 732 is formed to have the same length as the first gap circulation flow path 722.

Through the second gap discharge flow path 733, the cooling medium that has circulated in the second gap circulation flow path 732 and whose temperature has increased is discharged from the gap 33 to the outside of the casing 5 and is supplied to the heat exchanger 61A. The second gap discharge flow path 733 is a pipe that is connected to the heat exchanger 61A from the second gap circulation flow path 732 at the intermediate position in the stator 32 in the O axis direction. The second gap discharge flow path 733 is connected to an end of the second gap circulation flow path 732 on the downstream side in the O axis direction. The second gap discharge flow path 733 is disposed at an interval from the first gap discharge flow path 723 on the upstream side in the O axis direction. The second gap discharge flow path 733 is formed to have the same length as the first gap discharge flow path 723.

According to the compressor system 10 described above, similarly to the first embodiment, through the first gap circulation flow path 722 and the second gap circulation flow path 732, the rotor 31 and the stator 32 that are elongated in the O axis direction can be separately cooled in short divided sections which are an area on the downstream side and an area on the upstream side in the O axis direction. Therefore, an area to be cooled is divided into short sections in the O axis direction, and the rotor 31 and the stator 32 can be cooled by a cooling medium that circulates in another system. As a result, it is possible to prevent the occurrence of an area that is not sufficiently cooled. Therefore, the rotor 31 and the stator 32 heated due to heat generated between the rotor 31 and the stator 32 when the rotor 31 rotates can be efficiently cooled in the O axis direction. Therefore, it is possible to suppress the occurrence of a locally high-temperature area in the rotor 31 and the stator 32. As a result, it is possible to suppress a decrease in efficiency of the motor 3 and increase a lifespan.

When the first gap circulation flow path 722 and the second gap circulation flow path 732 are included, the cooling medium can be circulated in the gap 33. Therefore, compared to when the cooling medium is circulated inside the stator 32, the cooling medium can be circulated at a position closer to the rotor 31. Therefore, it is possible to improve cooling efficiency of the rotor 31.

While the third embodiment and the fourth embodiment of the present invention have been described in detail above with reference to the drawings, configurations and combinations thereof in the embodiments are only examples, and additions, omissions, substitutions and other modifications of the configurations can be made without departing from the scope of the present invention. In addition, the present invention is not limited to the third embodiment and the fourth embodiment and is only limited by the scope of the appended claims.

In addition, the heat exchanger 61A is not limited to a heat exchanger disposed outside the casing 5 as in this embodiment and a heat exchanger that can cool the cooling medium may be provided at any position. For example, the heat exchanger 61A may be disposed inside the casing 5. The number of heat exchangers 61A is not limited to one, and a plurality of heat exchangers 61A may be provided.

The present invention is not limited to the configuration of only the first flow path and the second flow path, and flow paths through which a plurality of cooling mediums are circulated such as a third flow path and a fourth flow path that are apart in the O axis direction and adjacent to each other may be additionally provided.

The circulation directions of the cooling mediums in the first flow path and the second flow path are not limited to opposite directions and may be the same direction.

### INDUSTRIAL APPLICABILITY

According to the above compressor system, when the cooling mediums are circulated through the first flow path and the second flow path that are formed apart in the axis direction, it is possible to effectively cool the rotor and the stator.

### REFERENCE SIGNS LIST

1, 10 Compressor system
O Axis
2 Compressor
21 Shaft
21a Thrust collar
22 Impeller
23 Housing
3 Motor
31 Rotor
32 Stator
33 Gap
4 Bearing
41 Journal bearing
42 Thrust bearing
5 Casing
51 Sealing member
6, 7, 6A, 7A Cooling portion
61, 61A Heat exchanger
64, 74 Cooling flow path
65, 75 Downstream side cooling flow path
651, 751 Introduction flow path
652, 752 Downstream side circulation flow path
653 Pump
66 Intermediate cooling flow path
661 Intermediate discharge flow path
662 Intermediate introduction flow path
69, 79 Upstream side cooling flow path
691, 791 Upstream side circulation flow path
692, 792 Discharge flow path
71 First heat exchanger
72 Second heat exchanger
76 First intermediate cooling flow path
761 First intermediate discharge flow path
762 First intermediate introduction flow path
77 Intermediate circulation flow path
78 Second intermediate cooling flow path
781 Second intermediate discharge flow path
82 Second intermediate introduction flow path
80 Connecting flow path
62 First internal flow path
621 First internal introduction flow path
621a Pump
622 First internal circulation flow path
623 First internal discharge flow path
63 Second internal flow path
631 Second internal introduction flow path
632 Second internal circulation flow path
633 Second internal discharge flow path
72A First gap flow path
721 First gap introduction flow path
722 First gap circulation flow path
723 First gap discharge flow path
73A Second gap flow path
731 Second gap introduction flow path
732 Second gap circulation flow path
733 Second gap discharge flow path

1. A compressor system, comprising:
a motor including a rotor configured to rotate about an axis and a stator that is disposed on an outer circumference side of the rotor;
a compressor configured to compress a working fluid by rotating together with the rotor;
a heat exchanger configured to cool a cooling medium that has circulated inside the stator or in a gap between the stator and the rotor; and
a cooling flow path through which the cooling medium that has circulated inside the stator or in the gap between the stator and the rotor is supplied to the heat exchanger and through which the cooling medium cooled by the heat exchanger is circulated again inside the stator or in the gap between the stator and the rotor,
wherein the cooling flow path includes an intermediate cooling flow path through which the cooling medium that circulates inside the stator or in the gap between the stator and the rotor is supplied to the heat exchanger along the way in an axis direction inside the stator or the gap between the stator and the rotor and through which the cooling medium cooled by the heat exchanger flows into the stator or the gap between the stator and the rotor.

2. (canceled)

3. The compressor system according to claim 1,
wherein a plurality of the intermediate cooling flow paths are provided in the axis direction with respect to the stator.

4. The compressor system according to claim 1,
wherein the heat exchanger cools the cooling medium using air.

5. The compressor system according to claim 1,
wherein the heat exchanger cools the cooling medium using fresh water.

6. The compressor system according to claim 1,
wherein the heat exchanger cools the cooling medium using seawater.

7. The compressor system according to claim 1,
wherein the heat exchanger cools the cooling medium using a compressed fluid extracted from the compressor.

8. A compressor system, comprising:
a motor including a rotor configured to rotate about an axis and a stator that is disposed on an outer circumference side of the rotor;
a compressor configured to compress a working fluid by rotating together with the rotor;
a first flow path which is disposed on one side in an axis direction and through which a cooling medium that has circulated inside the stator or in a gap between the stator and the rotor is recycled and is circulated again inside the stator or in the gap between the stator and the rotor; and
a second flow path which is disposed on the other side in the axis direction relative to the first flow path and is adjacent to the first flow path at an interval therefrom in the axis direction and through which a cooling medium that has circulated inside the stator or in the gap between the stator and the rotor is recycled and is circulated again inside the stator or in the gap between the stator and the rotor.

9. The compressor system according to claim 8, further comprising
a heat exchanger configured to cool the cooling medium that has circulated inside the stator or in the gap between the stator and the rotor.

10. The compressor system according to claim 9,
wherein the heat exchanger cools the cooling medium that circulates in the first flow path and cools the cooling medium that circulates in the second flow path.

11. The compressor system according to claim 10,
wherein the heat exchanger cools the cooling medium using air.

12. The compressor system according to claim 10,
wherein the heat exchanger cools the cooling medium using fresh water.

13. The compressor system according to claim 10,
wherein the heat exchanger cools the cooling medium using seawater.

14. The compressor system according to claim 8,
wherein the cooling medium is a compressed fluid extracted from the compressor.
